(19) United States
(12) Patent Application Publication
(10) Pub. No.: US 2004/0011991 A1
(43) Pub. Date: Jan. 22, 2004

(54) Use of a gettering agent in a chemical mechanical polishing and rinsing operation and apparatus therefor

(76) Inventor: Richard J. Markle, Austin, TX (US)

Correspondence Address: WILLIAMS, MORGAN & AMERSON, P.C., 10333 RICHMOND, SUITE 1100, HOUSTON, TX, 77042, US

(21) Appl. No.: 09/881,086

(22) Filed: Jun. 13, 2001

(51) Int. Cl. C09K 13/00

(52) U.S. Cl. 252/79.1

(57) ABSTRACT

An abrasive slurry that is capable of being used in a chemical mechanical polishing operation includes a plurality of abrasive particles, a matrix capable of carrying the plurality of abrasive particles, and a gettering agent. The gettering agent has an affinity for a material removed during the chemical mechanical polishing operation. A rinsing fluid that is capable of being used in a post-chemical mechanical polishing rinsing cycle. The rinsing fluid includes a gettering agent having an affinity for a residue material resulting from the chemical mechanical polishing operation.

### BACKGROUND OF THE INVENTION

1. Field of the Invention

This invention relates to the planarization of semiconductor wafers, and in one aspect, to a use of a gettering agent in a chemical mechanical polishing and rinsing operation, and an apparatus therefor.

2. Description of the Related Art

Chemical mechanical polishing (CMP) is a widely used means of planarizing silicon dioxide as well as other types of process layers on semiconductor wafers. Chemical mechanical polishing typically utilizes an abrasive slurry disbursed in an alkaline or acidic solution to planarize the surface of the wafer through a combination of mechanical and chemical action. Generally, a chemical mechanical polishing tool includes a polishing device positioned above a rotatable circular platen or table on which a polishing pad is mounted. The polishing device may include one or more rotating carrier heads to which wafers may be secured, typically through the use of vacuum pressure. In use, the platen may be rotated and an abrasive slurry may be disbursed onto the polishing pad. Once the abrasive slurry has been applied to the polishing pad, a downward force may be applied to each rotating carrier head to press the attached wafer against the polishing pad. As the wafer is pressed against the polishing pad, the surface of the wafer is mechanically and chemically polished. Following CMP, the wafer is thoroughly rinsed to remove residue from the wafer surface.

As semiconductor devices are scaled down, the importance of chemical mechanical polishing to the fabrication process increases. In particular, it becomes increasingly important to control and minimize within-wafer topography variations. For example, in one embodiment, to minimize spatial variations in downstream photolithography and etch processes, it is necessary for the oxide thickness of a wafer to be as uniform as possible (i.e., it is desirable for the surface of the wafer to be as planar as possible.)

With individual devices getting smaller and circuits operating faster, copper has become very important to the semiconductor industry. Signals must move fast enough through the metal system to prevent processing delays. In this setting, aluminum, due to its limited electrical conductivity, restricts speed. Copper is a better conductor than aluminum with a resistance of 1.7 micro-ohm cm as compared to a 3.1 micro-ohm cm value for aluminum. Further, copper is well suited for use in dual-damascene processes, as it can be deposited in high aspect ratio vias and plugs, whereas aluminum is difficult to use in this situation. Copper, however, migrates easily into silicon substrates and such migration impairs device performance.

While global planarity is the goal of CMP, the advent of multiple-metal schemes challenges that goal. Copper poses particular problems, in that copper that is deposited into the trenches and vias of a damascene-patterning system results in a conductor having a lower density in the center. During the CPM process, the center portion is removed faster than the surrounding structure, leaving a dish shape. Further, copper residue, left on process layers of the wafer can cause electrical shorting within the semiconductor device.

The present invention is directed to overcoming, or at least reducing the effects of, one or more of the problems set forth above.

### SUMMARY OF THE INVENTION

According to one aspect of the present invention, an abrasive slurry that is capable of being used in a chemical mechanical polishing operation includes a plurality of abrasive particles, a matrix capable of carrying the plurality of abrasive particles, and a gettering agent. The gettering agent has an affinity for a material removed during the chemical mechanical polishing operation.

A further aspect of the present invention is a rinsing fluid that is capable of being used in a post-chemical mechanical polishing rinsing cycle. The rinsing fluid includes a gettering agent having an affinity for a residue material resulting from the chemical mechanical polishing operation.

### BRIEF DESCRIPTION OF THE DRAWINGS

The invention may be understood by reference to the following description taken in conjunction with the accompanying drawings, in which like reference numerals identify like elements, and in which:

FIG. 1 is a flowchart illustrating one embodiment of the present invention;

FIG. 2 is a flowchart illustrating another embodiment of the present invention;

FIG. 3 is a flowchart illustrating a further embodiment of the present invention;

FIG. 4 is a flowchart illustrating another embodiment of the present invention;

FIG. 5 is a block diagram of a CMP system according to the present invention; and

FIG. 6 is a block diagram of a rinsing system according to the present invention.

While the invention is susceptible to various modifications and alternative forms, specific embodiments thereof have been shown by way of example in the drawings, and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

A gettering agent has an affinity for a particular specie and it is used to bind up the specie so as to inhibit its chemical activity, i.e., to inhibit its chemical affinity for another specie. The gettering agent, for example, can be a chelating, precipitating, or complexing agent, or the like. This can be particularly advantageous in a CMP process to enhance the material removal rate of the process. For example, a copper gettering agent used in a CMP process can enhance the copper removal rate by binding up copper so that it will not readily chemically combine with another specie. Use of gettering agents also affects the chemical material removal rate of the CMP process by depleting the dissolved copper in the slurry, thus allowing the slurry to chemically remove more copper from the wafer, as can be seen from the following relationships:

Cu_{solid}+Slurry→Cuᵢₒₙ

Cuᵢₒₙ+Getter→CuGetter

Further, a gettering agent, when used in a rinsing fluid to rinse a wafer that has undergone a CMP process, can remove trace amounts of copper left on the surface of the wafer by binding up the copper so that it will not readily combine with another specie. Examples of such gettering agents for copper are ethylene diamine, ethylene diaminetetraacetate (EDTA) ions, oxalate ions, ortho-phenanthroline, carbonate ions, bipyridine, pyridine, thiourea, cyanide, and the like. Some oxidizing acids, sulfur-bearing compounds, ammonia, cyanides, and the like are used to enhance the removal or erosion rate of copper from copper layers. In certain circumstances, these compounds can also act as gettering agents.

According to one embodiment of the present invention, an abrasive slurry that is capable of use in a chemical mechanical polishing operation includes a plurality of abrasive particles, a matrix capable of carrying the plurality of abrasive particles, and a gettering agent. The gettering agent has an affinity for a material removed in the chemical mechanical polishing operation. The gettering agent enhances the chemical polishing action of a typical chemical mechanical polishing process in that the material being removed from a process layer (e.g., copper from a conductive layer) is bound up so that the chemical polishing action can be more efficient by reducing the concentration of a chemically-active form of the material in the abrasive slurry. Examples of such abrasive particles are alumina, colloidal silica, fumed silica, ceria, diamond, and the like, in any suitable combination.

In another embodiment, a rinsing fluid is provided that is capable of being used in a post-CMP rinsing cycle. The rinsing fluid includes a gettering agent having an affinity for a residue material resulting from the CMP operation. Residue material contained in the rinsing fluid is bound up by the gettering agent so that it is inhibited from chemically combining with other species. For example, residue remaining on the surface of a process layer after the CMP process may contain copper, which if left on the process layer, may cause shorting or other improper operation of the semiconductor device. In this situation, a rinsing fluid containing a copper gettering agent is desirable, since the gettering agent would bind up the copper residue and prevent it from remaining on or migrating into the process layer. Some gettering agents can combine with copper (or another material being removed in the rinsing process) to form precipitates. As these precipitates can remain on the surface being rinsed, one embodiment of the present invention provides circulating filtration of the rinsing fluid to remove such precipitates from the rinsing fluid.

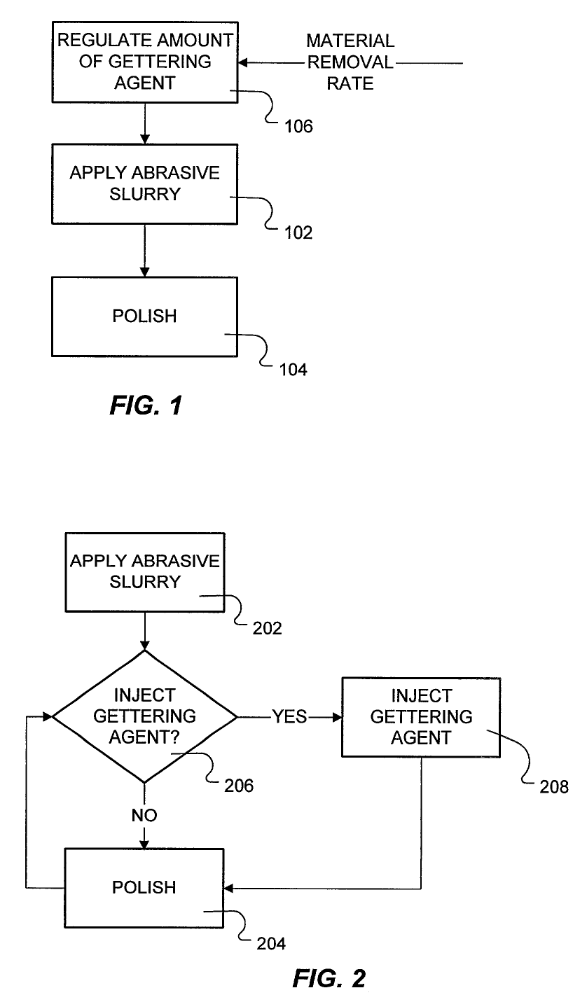

Referring to FIG. 1, the illustrated embodiment provides a CMP process including applying an abrasive slurry to a polishing pad (block 102) and causing a relative motion between a process layer on a wafer and the polishing pad, while the polishing pad is in contact with the process layer, to polish the process layer (block 104). The abrasive slurry, which is between the polishing pad and the process layer, includes a gettering agent having an affinity for a material to be removed during the CMP process. Thus, as the CMP process removes material from the process layer, the gettering agent in the abrasive slurry binds up the removed material. In one embodiment of the present invention, the CMP method includes regulating an amount of the gettering agent in the abrasive slurry according to a desired material removal rate (block 106). The amount of the gettering agent can be increased to increase the material removal rate and can be decreased to decrease the material removal rate.

Those skilled in the art will appreciate that the material removal rate

$$\frac{\ddot{A} x}{\ddot{A} t}$$

may be understood with reference to Preston's equation, which is defined as:

$$\frac{\ddot{A} x}{\ddot{A} t} = Kp \cdot \frac{F}{A} \cdot v$$

wherein:

$$\frac{\ddot{A} x}{\ddot{A} t} = the material removal rate ;$$

Kp=an empirically-determined scale factor;

F=a force applied between a polishing pad and a process layer on a wafer;

A=an area between the polishing pad and the process layer on the wafer; and

v=a relative linear velocity of the wafer with respect to the polishing pad.

The two main variables affecting the material removal rate are the applied force and the relative linear velocity. Increasing the applied force to increase the material removal rate can amplify the dishing of copper deposited in trenches and vias. In one embodiment of the present invention, gettering agents, added to the abrasive slurry, provide another variable for regulating the material removal rate and for ultimately diminishing dishing. Preston's equation can thus be modified according to Equation (1):

$$\frac{\ddot{A} x}{\ddot{A} t} = Kp \cdot \frac{F}{A} \cdot v \cdot Eg \qquad Equation ( 1 )$$

wherein:

$$\frac{\ddot{A} x}{\ddot{A} t} = the material removal rate ;$$

Kp=an empirically-determined scale factor;

F=a force applied between a polishing pad and a process layer on a wafer;

A=an area between the polishing pad and the process layer on the wafer;

v=a relative linear velocity of the wafer with respect to the polishing pad; and

Eg=an erosion factor due to the gettering agent.

Thus, a CMP method according to the present invention includes regulating a material removal rate according to Equation (1).

Referring to FIG. 2, another embodiment of the present invention provides a CMP method including applying an abrasive slurry to a polishing pad (block 202) and causing a relative motion between a process layer on a wafer and the polishing pad, while the polishing pad is in contact with the process layer, to polish the process layer (block 204). The abrasive slurry is between the polishing pad and the process layer. The gettering agent is introduced into the abrasive slurry at a predetermined (blocks 206, 208). Thus, the gettering agent can be introduced at any point in time during the polishing cycle. For example, it may be advantageous to introduce the gettering agent at a beginning of the period of time during which polishing is being performed. Or, it may be more advantageous to introduce the gettering agent at an intermediate time during the period of time during which polishing is being performed. Alternatively, the gettering agent can be introduced near an end of the period of time during which polishing is being performed.

In one embodiment, the amount of the gettering agent introduced into the abrasive slurry is regulated according to the desired material removal rate. The amount of the gettering agent can be increased to increase the material removal rate and can be decreased to decrease the material removal rate. As discussed above, the material removal rate can be regulated according to Equation (1).

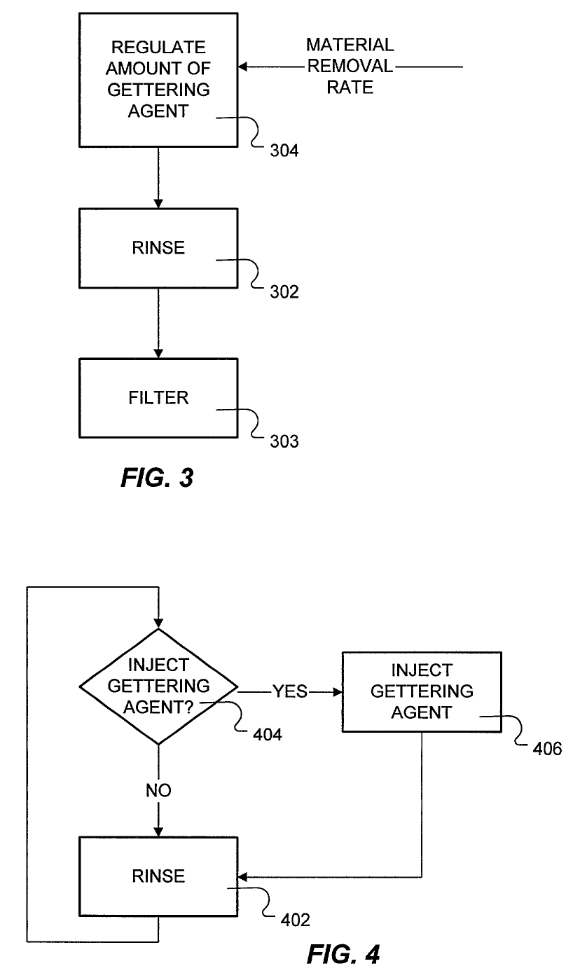

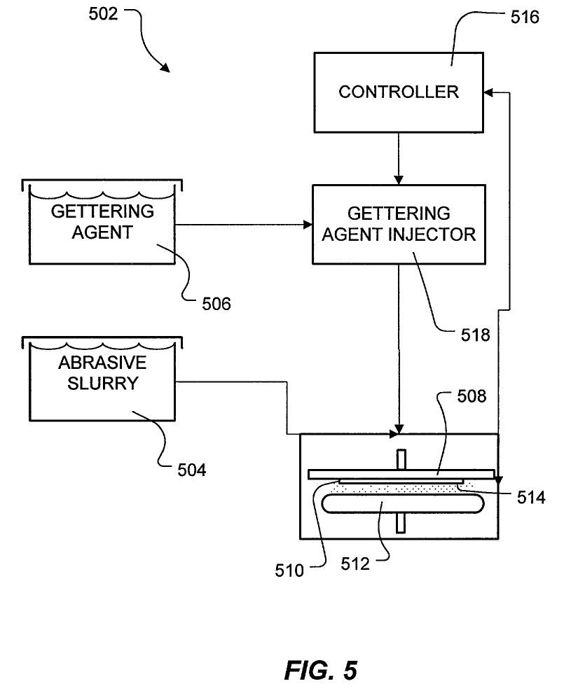

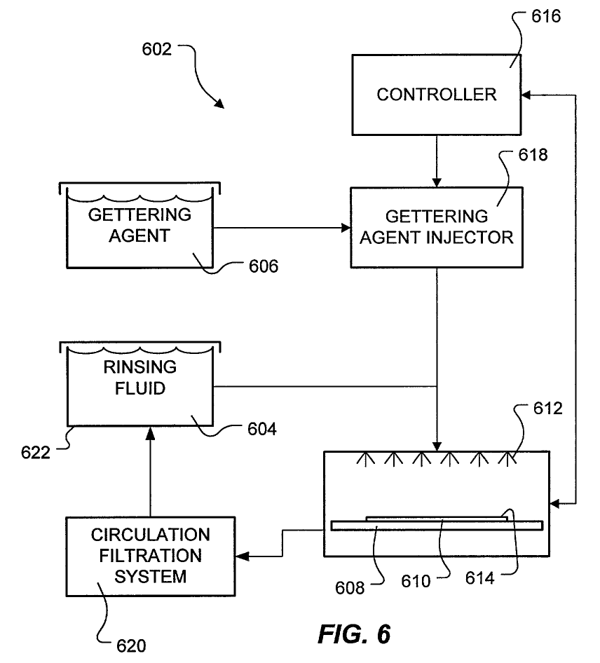

As presented above, gettering agents can be used in rinsing fluids to remove trace amounts of materials left on the surface of the process layer by binding up the materials so that they are no longer chemically active. Accordingly, as illustrated in FIG. 3, a rinsing method according to one embodiment of the present invention includes rinsing a process layer on a wafer (block 302) with a rinsing fluid including a gettering agent having an affinity for a residue material. The amount of the gettering agent can be regulated according to a desired residue material removal rate (block 304). The amount of the gettering agent can be increased to increase the residue material removal rate and can be decreased to decrease the residue material removal rate. If a gettering agent is used that combines with the residue material to form a precipitate, the rising fluid is filtered (block 303) in one embodiment of the present invention to remove the precipitated material.

According to another embodiment of the present invention, a rinsing method includes rinsing the process layer on the wafer with the rinsing fluid (block 402) and introducing the gettering agent into the rinsing fluid at a predetermined time (blocks 404, 406). Thus, the gettering agent may not be present during a portion of the rinsing cycle. It may be advantageous, for example, for the gettering agent to be introduced at the beginning of the period of time during which the process layer is being rinsed, or it may be advantageous for the gettering agent to be introduced at an intermediate time during the period of time during which the process layer is being rinsed. Further, the gettering agent may be introduced near an end of the period of time during which the process layer is being rinsed. The amount of the gettering agent introduced into the rinsing fluid is, in one embodiment, regulated according to a desired residue material removal rate. The amount of the gettering agent can be increased to increase the residue material removal rate and can be decreased to decrease the residue material removal rate.

In another embodiment of the present invention, a CMP system 502, capable of using an abrasive slurry 504 containing a gettering agent 506, is provided including a wafer chuck 508 capable of holding a semiconductor wafer 510 and a polishing pad 512. The polishing pad 512 is capable of polishing a process layer 514 on the semiconductor wafer 510. The system 502 further includes a controller 516 that is capable of controlling an amount of the gettering agent 506 in the abrasive slurry 504. In one embodiment, the system 502 further includes a gettering agent injector 518 that is capable of injecting the gettering agent 506 into the abrasive slurry 504. The controller 516 is interconnected with the gettering agent injector 518 to control the amount of the gettering agent 506 injected into the abrasive slurry 504. In another embodiment, the controller 516 controls the amount of the gettering agent 506 in the abrasive slurry 504 based upon a desired material removal rate. The controller 516 can also control the polishing operation performed by the CMP system 502 according to Equation (1).

In a further embodiment, a rinsing system 602 is provided that is capable of using a rinsing fluid 604 containing a gettering agent 606. The rinsing system 602 has a wafer chuck 608 that is capable of holding a semiconductor wafer 610, a nozzle 612 capable of spraying the wafer 610 and the process layer 614 with the rinsing fluid 604, and a controller 616 capable of controlling an amount of the gettering agent 606 in the rinsing fluid 604. One embodiment of the present invention provides a gettering agent injector 618 capable of injecting the gettering agent 606 into the rinsing fluid 604. The controller 616 is interconnected with the gettering agent injector 618 to control the amount of the gettering agent 606 injected into the rinsing agent 604. Further, the controller 616 can control the amount of the gettering agent 606 in the rinsing fluid 604 based upon a desired material removal rate. If the gettering agent 606 (or a particular gettering agent in a combination of gettering agents) used in the rinsing fluid 604 combines with the material being removed to form a precipitate, it may be desirable to remove the precipitate from the rinsing fluid 604. Accordingly, in one embodiment of the present invention, a circulation filtration system 620 is provided to filter the rinsing fluid 604, after it has been used to rinse the wafer 610 and the process layer 614 and before the rinsing fluid 604 is returned to its storage tank 622.

The present invention further encompasses an apparatus having means for performing the embodiments of the method of the invention described herein and their equivalents.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An abrasive slurry capable of use in a chemical mechanical polishing operation, comprising:
a plurality of abrasive particles;
a matrix capable of carrying the plurality of abrasive particles; and
a gettering agent having an affinity for a material removed in the chemical mechanical polishing operation.

2. An abrasive slurry, according to claim 1, wherein at least a portion of the plurality of abrasive particles are selected from the group consisting of alumina, colloidal silica, fumed silica, ceria, and diamond.

3. An abrasive slurry, according to claim 1, wherein the gettering agent has an affinity for copper.

4. An abrasive slurry, according to claim 1, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

5. A rinsing fluid capable of use in a post-chemical mechanical polishing rinsing cycle, comprising a gettering agent having an affinity for a residue material resulting from a chemical mechanical polishing operation.

6. A rinsing fluid, according to claim 5, wherein the gettering agent has an affinity for copper.

7. A rinsing fluid, according to claim 5, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

8. A chemical mechanical polishing method, comprising:
applying an abrasive slurry comprising a gettering agent to a polishing pad, the gettering agent having an affinity for a material to be removed; and
causing a relative motion between a process layer on a wafer and the polishing pad while the polishing pad is in contact with the process layer, wherein the abrasive slurry is contacts the process layer and the polishing pad.

9. A chemical mechanical polishing method, according to claim 8, wherein the gettering agent has an affinity for copper.

10. A chemical mechanical polishing method, according to claim 8, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

11. A chemical mechanical polishing method, according to claim 8, further comprising regulating an amount of the gettering agent in the abrasive slurry according to a desired material removal rate.

12. A chemical mechanical polishing method, according to claim 11, wherein regulating the amount of the gettering agent comprises:
increasing the amount of the gettering agent in the abrasive slurry to increase a material removal rate; and
decreasing the amount of the gettering agent in the abrasive slurry to decrease the material removal rate.

13. A chemical mechanical polishing method, according to claim 8, further comprising regulating a material removal rate according to an equation:
$$\frac{\ddot{A} x}{\ddot{A} t} = Kp \cdot \frac{F}{A} \cdot v \cdot Eg$$
wherein:
$$\frac{\ddot{A} x}{\ddot{A} t} = the material removal rate ;$$
Kp=an empirically-determined scale factor;
F=a force applied between the polishing pad and the process layer on the wafer;
A=an area between the polishing pad and the process layer on the wafer;
v=a relative linear velocity of the wafer with respect to the polishing pad; and
Eg=an erosion factor due to the gettering agent.

14. A chemical mechanical polishing method, comprising:
applying an abrasive slurry to a polishing pad;
causing a relative motion between a wafer and the polishing pad for a period of time while the polishing pad is in contact with the wafer, wherein the abrasive slurry is in contact with the wafer and the polishing pad; and
introducing a gettering agent into the abrasive slurry at a predetermined time during the period of time.

15. A chemical mechanical polishing method, according to claim 14, wherein the gettering agent has an affinity for copper.

16. A chemical mechanical polishing method, according to claim 14, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

17. A chemical mechanical polishing method, according to claim 14, wherein the gettering agent is introduced at a beginning of the period of time.

18. A chemical mechanical polishing method, according to claim 14, wherein the gettering agent is introduced at an intermediate time during the period of time.

19. A chemical mechanical polishing method, according to claim 14, wherein the gettering agent is introduced near an end of the period of time.

20. A chemical mechanical polishing method, according to claim 14, further comprising regulating an amount of the gettering agent introduced into the abrasive slurry according to a desired material removal rate.

21. A chemical mechanical polishing method, according to claim 20, wherein regulating the amount of the gettering agent comprises:
increasing the amount of the gettering agent introduced into the abrasive slurry to increase a material removal rate; and
decreasing the amount of the gettering agent introduced into the abrasive slurry to decrease the material removal rate.

22. A chemical mechanical polishing method, according to claim 14, further comprising regulating a material removal rate according to an equation:
$$\frac{\ddot{A} x}{\ddot{A} t} = Kp \cdot \frac{F}{A} \cdot v \cdot Eg$$
wherein:
$$\frac{\ddot{A} x}{\ddot{A} t} = the material removal rate ;$$
Kp=an empirically-determined scale factor;
F=a force applied between a polishing pad and a process layer on a wafer;
A=an area between the polishing pad and the process layer on the wafer;
v=a relative linear velocity of the wafer with respect to the polishing pad; and
Eg=an erosion factor due to the gettering agent.

23. A rinsing method, comprising rinsing a wafer with a rinsing fluid comprising a gettering agent having an affinity for a residue material.

24. A rinsing method, according to claim 23, wherein the gettering agent has an affinity for copper.

25. A rinsing method, according to claim 23, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

26. A rinsing method, according to claim 23, further comprising regulating an amount of the gettering agent in the rinsing fluid based upon a desired residue material removal rate.

27. A rinsing method, according to claim 26, wherein regulating the amount of the gettering agent comprises:
increasing the amount of the gettering agent in the rinsing fluid to increase a residue material removal rate; and
decreasing the amount of the gettering agent in the rinsing fluid to decrease the residue material removal rate.

28. A rinsing method, according to claim 23, further comprising filtering the rinsing fluid.

29. A rinsing method, comprising:
rinsing a wafer with a rinsing fluid for a period of time; and
introducing a gettering agent into the rinsing fluid at a predetermined time during the period of time.

30. A rinsing method, according to claim 29, wherein the gettering agent has an affinity for copper.

31. A rinsing method, according to claim 29, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

32. A rinsing method, according to claim 29, wherein the gettering agent is introduced at a beginning of the period of time.

33. A rinsing method, according to claim 29, wherein the gettering agent is introduced at an intermediate time during the period of time.

34. A rinsing method, according to claim 28, wherein the gettering agent is introduced near an end of the period of time.

35. A rinsing method, according to claim 29, further comprising regulating an amount of the gettering agent introduced into the rinsing fluid according to a desired residue material removal rate.

36. A rinsing method, according to claim 35, wherein regulating the amount of the gettering agent comprises:
increasing the amount of the gettering agent introduced into the rinsing fluid to increase a residue material removal rate; and
decreasing the amount of the gettering agent introduced into the rinsing fluid to decrease the residue material removal rate.

37. A rinsing method, according to claim 29, further comprising filtering the rinsing fluid.

38. A chemical mechanical polishing system capable of using an abrasive slurry containing a gettering agent, comprising:
a wafer chuck capable of holding a semiconductor wafer;
a polishing pad capable of polishing a process layer on the semiconductor wafer; and
a controller capable of controlling an amount of the gettering agent in the abrasive slurry.

39. A chemical mechanical polishing system, according to claim 38, further comprising a gettering agent injector capable of injecting the gettering agent into the abrasive slurry, wherein the controller is interconnected with the gettering agent injector to control the amount of the gettering agent injected into the abrasive slurry.

40. A chemical mechanical polishing system, according to claim 38, wherein the controller controls the amount of the gettering agent in the abrasive slurry based upon a desired material removal rate.

41. A chemical mechanical polishing system, according to claim 38, wherein the controller is capable of controlling a polishing operation performed by the chemical mechanical polishing system according to an equation:
$$\frac{\ddot{A} x}{\ddot{A} t} = Kp \cdot \frac{F}{A} \cdot v \cdot Eg$$
wherein:
$$\frac{\ddot{A} x}{\ddot{A} t} = a material removal rate ;$$
Kp=an empirically-determined scale factor;
F=a force applied between the polishing pad and the process layer on a wafer;
A=an area between the polishing pad and the process layer on the wafer;
v=a relative linear velocity of the wafer with respect to the polishing pad; and
Eg=an erosion factor due to the gettering agent.

42. A rinsing system capable of using a rinsing fluid containing a gettering agent, comprising:
a wafer chuck capable of holding a semiconductor wafer;
a nozzle capable of spraying the semiconductor wafer with the rinsing fluid; and
a controller capable of controlling an amount of the gettering agent in the rinsing fluid.

43. A rinsing system, according to claim 42, further comprising a gettering agent injector capable of injecting the gettering agent into the rinsing fluid, wherein the controller is interconnected with the gettering agent injector to control the amount of the gettering agent injected into the rinsing agent.

44. A rinsing system, according to claim 42, wherein the controller controls the amount of the gettering agent in the rinsing agent based upon a desired material removal rate.

45. A rinsing system, according to claim 42, further comprising a circulating filtration system capable of filtering the rinsing fluid.

46. A chemical mechanical polishing apparatus, comprising:
means for applying an abrasive slurry comprising a gettering agent to a polishing pad, the gettering agent having an affinity for a material to be removed; and
means for causing a relative motion between a process layer on a wafer and the polishing pad while the polishing pad is in contact with the process layer, wherein the abrasive slurry is between the process layer and the polishing pad.

47. A chemical mechanical polishing apparatus, according to claim 46, wherein the gettering agent has an affinity for copper.

48. A chemical mechanical polishing apparatus, according to claim 46, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

49. A chemical mechanical polishing apparatus, according to claim 46, further comprising means for regulating an amount of the gettering agent in the abrasive slurry according to a desired material removal rate.

50. A chemical mechanical polishing apparatus, according to claim 49, wherein the means for regulating the amount of the gettering agent comprises:
means for increasing the amount of the gettering agent in the abrasive slurry to increase a material removal rate; and
means for decreasing the amount of the gettering agent in the abrasive slurry to decrease the material removal rate.

51. A chemical mechanical polishing apparatus, according to claim 46, further comprising means for regulating a material removal rate according to an equation:
$$\frac{\ddot{A} x}{\ddot{A} t} = k p \cdot \frac{F}{A} \cdot v \cdot E g$$
wherein:
$$\frac{\ddot{A} x}{\ddot{A} t} = a material removal rate ;$$
Kp=an empirically-determined scale factor;
F=a force applied between the polishing pad and the process layer on the wafer;
A=an area between the polishing pad and the process layer on the wafer;
v=a relative linear velocity of the wafer with respect to the polishing pad; and
Eg=an erosion factor due to the gettering agent.

52. A chemical mechanical polishing apparatus, comprising:
means for applying an abrasive slurry to a polishing pad;
means for causing a relative motion between a wafer and the polishing pad while the polishing pad is in contact with the wafer, wherein the abrasive slurry is between the wafer and the polishing pad; and
means for introducing a gettering agent into the abrasive slurry at a predetermined time during the period of time.

53. A chemical mechanical polishing apparatus, according to claim 52, wherein the gettering agent has an affinity for copper.

54. A chemical mechanical polishing apparatus, according to claim 52, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

55. A chemical mechanical polishing apparatus, according to claim 52, wherein the gettering agent is introduced at a beginning of the period of time.

56. A chemical mechanical polishing apparatus, according to claim 52, wherein the gettering agent is introduced at an intermediate time during the period of time.

57. A chemical mechanical polishing apparatus, according to claim 52, wherein the gettering agent is introduced near an end of the period of time.

58. A chemical mechanical polishing apparatus, according to claim 52, further comprising means for regulating an amount of the gettering agent introduced into the abrasive slurry according to a desired material removal rate.

59. A chemical mechanical polishing apparatus, according to claim 58, wherein the means for regulating the amount of the gettering agent comprises:
means for increasing the amount of the gettering agent introduced into the abrasive slurry to increase a material removal rate; and
means for decreasing the amount of the gettering agent introduced into the abrasive slurry to decrease the material removal rate.

60. A chemical mechanical polishing apparatus, according to claim 52, further comprising means for regulating a material removal rate according to an equation:
$$\frac{\ddot{A} x}{\ddot{A} t} = k p \cdot \frac{F}{A} \cdot v \cdot E g$$
wherein:
$$\frac{\ddot{A} x}{\ddot{A} t} = a material removal rate ;$$
Kp=an empirically-determined scale factor;
F=a force applied between the polishing pad and the process layer on a wafer;
A=an area between the polishing pad and the process layer on the wafer;
v=a relative linear velocity of the wafer with respect to the polishing pad; and
Eg=an erosion factor due to the gettering agent.

61. A rinsing apparatus, comprising means for rinsing a wafer with a rinsing fluid comprising a gettering agent having an affinity for a residue material.

62. A rinsing apparatus, according to claim 61, wherein the gettering agent has an affinity for copper.

63. A rinsing apparatus, according to claim 61, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

64. A rinsing apparatus, according to claim 61, further comprising means for regulating an amount of the gettering agent in the rinsing fluid based upon a desired residue material removal rate.

65. A rinsing apparatus, according to claim 64, wherein the means for regulating the amount of the gettering agent comprises:
means for increasing the amount of the gettering agent in the rinsing fluid to increase a residue material removal rate; and
means for decreasing the amount of the gettering agent in the rinsing fluid to decrease the residue material removal rate.

66. A rinsing apparatus, comprising:
means for rinsing a wafer with a rinsing fluid; and
means for introducing a gettering agent into the rinsing fluid at a predetermined time during the period of time.

67. A rinsing apparatus, according to claim 66, wherein the gettering agent has an affinity for copper.

68. A rinsing apparatus, according to claim 66, wherein the gettering agent is selected from the group consisting of ethylene diamine, ethylene diaminetetraacetate (EDTA) ions, oxalate ions, ortho-phenanthroline, carbonate ions, bipyridine, pyridine, thiourea, cyanide, an oxidizing acid, a sulfur-bearing compound, and ammonia.

69. A rinsing apparatus, according to claim 66, wherein the gettering agent is introduced at a beginning of the period of time.

70. A rinsing apparatus, according to claim 66, wherein the gettering agent is introduced at an intermediate time during the period of time.

71. A rinsing apparatus, according to claim 66, wherein the gettering agent is introduced near an end of the period of time.

72. A rinsing apparatus, according to claim 66, further comprising means for regulating an amount of the gettering agent introduced into the rinsing fluid according to a desired residue material removal rate.

73. A rinsing apparatus, according to claim 72, wherein the means for regulating the amount of the gettering agent comprises:
means for increasing the amount of the gettering agent introduced into the rinsing fluid to increase a residue material removal rate; and
means for decreasing the amount of the gettering agent introduced into the rinsing fluid to decrease the residue material removal rate.

74. A rinsing apparatus, according to claim 66, further comprising a circulating filtration system capable of filtering the rinsing fluid.
